(19) United States
(12) Patent Application Publication
(10) Pub. No.: US 2015/0234517 A1
(43) Pub. Date: Aug. 20, 2015

(54) DISPLAY APPARATUS AND METHOD AND COMPUTER PROGRAM PRODUCT

(71) Applicant: Kabushiki Kaisha Toshiba, Tokyo (JP)

(72) Inventors: Kazunori IMOTO, Kawasaki Kanagawa (JP); Shihomi TAKAHASHI, Yokohama Kanagawa (JP); Yuto YAMAJI, Kawasaki Kanagawa (JP); Isao MIHARA, Shinagawa Tokyo (JP); Tomoyuki SHIBATA, Kawasaki Kanagawa (JP); Toshiaki NAKASU, Shinagawa Tokyo (JP)

(21) Appl. No.: 14/624,103

(22) Filed: Feb. 17, 2015

(30) Foreign Application Priority Data
Feb. 20, 2014 (JP) 2014-030964

(51) Int. Cl. G06F 3/041; G06F 3/0488

(52) U.S. Cl. CPC G06F 3/0414; G06F 3/0488; G06F 2203/04104

(57) ABSTRACT

According to an embodiment, a display apparatus includes an acquisition controller, a region setting controller, a change controller, and a display controller. The acquisition controller sequentially acquires a point position of an input device on a display that displays content, and a pressure acting on the point position. The region setting controller sets a region of interest on the display, based on the point position and the pressure that are sequentially acquired. The change controller changes, based on the pressure, substance displayed in the region of interest, of the content, while the region of interest is fixed. The display controller displays the changed substance in the region of interest.

### CROSS-REFERENCE TO RELATED APPLICATIONS

This application is based upon and claims the benefit of priority from Japanese Patent Application No. 2014-030964 filed on Feb. 20, 2014; the entire contents of which are incorporated herein by reference.

### FIELD

Embodiments described herein relate generally to a display apparatus, a display method, and a computer program product.

### BACKGROUND

In a display apparatus provided with a pen input interface, there is known a technique of, by utilizing pen operation, changing substance of content displayed in a region of interest through zooming (zooming-in and zooming-out) and the like.

However, in the above-described conventional art, the change of substance of content displayed in a region of interest causes the size of the region of interest to also change. As a result, the visibility of an outside of the region of interest reduces.

### BRIEF DESCRIPTION OF THE DRAWINGS

FIG. 1 is a configuration diagram illustrating an example of the display apparatus according to the first embodiment;

FIG. 2 is a diagram illustrating an example of the tilt angle and the azimuth angle according to the first embodiment;

FIG. 3 is a diagram for explaining an example of the analysis method of a gesture according to the first embodiment;

FIG. 4 is a diagram for explaining the example of the analysis method of a gesture according to the first embodiment;

FIG. 5 is a diagram for explaining an example of the setting method of a region of interest according to the first embodiment;

FIG. 6 is a diagram for explaining the example of the setting method of a region of interest according to the first embodiment;

FIG. 7 is an illustrative diagram of an example of the determination method of a closed loop according to the first embodiment;

FIG. 8 is an illustrative diagram of an example of the determination method of a closed loop according to the first embodiment;

FIG. 9 is an illustrative diagram of an example of the determination method of a closed loop according to the first embodiment;

FIG. 10 is an illustrative diagram of an example of the pressure level according to the first embodiment;

FIG. 11 is an illustrative diagram of an example of the changed substance in a region of interest according to the first embodiment;

FIG. 12 is an illustrative diagram of an example of the changed substance in a region of interest according to the first embodiment;

FIG. 13 is an illustrative diagram of an example of the changed substance in a region of interest according to the first embodiment;

FIG. 14 is a flow chart illustrating an example of the region setting process according to the first embodiment;

FIG. 15 is a flow chart illustrating an example of the zoom state setting process according to the first embodiment;

FIG. 16 is a flow chart illustrating an example of the change process according to the first embodiment;

FIG. 17 is a block diagram illustrating a configuration example of the display apparatus according to the second embodiment;

FIG. 18 is an illustrative diagram of an example of the changed substance in a region of interest according to the second embodiment;

FIG. 19 is an illustrative diagram of an example of the changed substance in a region of interest according to the second embodiment;

FIG. 20 is an illustrative diagram of an example of the changed substance in a region of interest according to the modification;

FIG. 21 is an illustrative diagram of an example of the changed substance in a region of interest according to the modification;

FIG. 22 is a diagram illustrating a hardware configuration example of the display apparatuses according to the embodiments and the modification; and

FIG. 23 is a diagram illustrating an example of the display systems according to the embodiments and the modification.

### DETAILED DESCRIPTION

According to an embodiment, a display apparatus includes an acquisition controller, a region setting controller, a change controller, and a display controller. The acquisition controller sequentially acquires a point position of an input device on a display that displays content, and a pressure acting on the point position. The region setting controller sets a region of interest on the display, based on the point position and the pressure that are sequentially acquired. The change controller changes, based on the pressure, substance displayed in the region of interest, of the content, while the region of interest is fixed. The display controller displays the changed substance in the region of interest.

Embodiments will be described in detail below with reference to accompanying drawings.

### First Embodiment

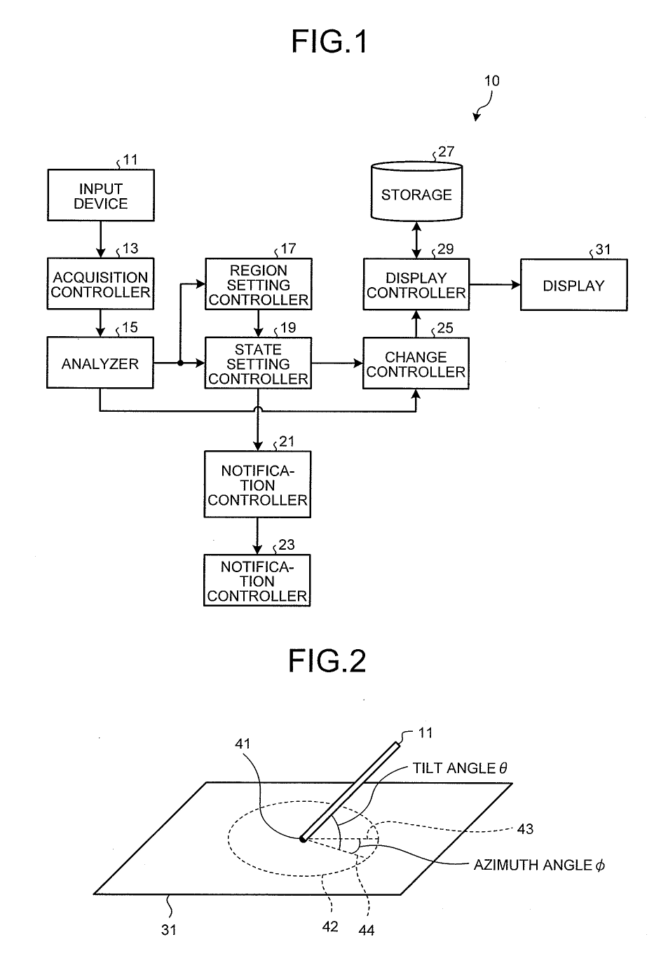

FIG. 1 is a configuration diagram illustrating an example of a display apparatus 10 according to a first embodiment. As illustrated in FIG. 1, the display apparatus 10 includes an input unit 11, an acquisition unit 13, an analyzer 15, a region setting unit 17, a state setting unit 19, a notification controller 21, a notification unit 23, a change unit 25, a storage 27, a display controller 29, and a display 31.

The input unit 11 can be implemented by an input device capable of inputting by handwriting, such as an electronic pen, a touch panel, a touch pad and a mouse. The acquisition unit 13, the analyzer 15, the region setting unit 17, the state setting unit 19, the notification controller 21, the change unit 25, and the display controller 29 may be implemented by, for example, allowing a processor such as a CPU (Central Processing Unit) to execute a program, that is, by software; may be implemented by hardware such as an IC (Integrated Circuit); or may be implemented by a combination of software and hardware. The notification unit 23 can be implemented by a notification device such as a touch panel display, a speaker, a lamp and a vibrator. It is noted that when the notification unit 23 is implemented by a touch panel display, the display 31 may play a role of the notification unit 23. The storage 27 can be implemented by, for example, a magnetically, optically, or electrically storable storage device such as an HDD (Hard Disk Drive), an SSD (Solid State Drive), a memory card, an optical disk, a ROM (Read Only Memory), and a RAM (Random Access Memory). The display 31 can be implemented by, for example, a display device such as a touch panel display.

The input unit 11 sequentially inputs, to the display apparatus 10, a point position of the input unit 11 on the display 31 that displays content, and a pressure acting on the point position. The input unit 11 may further sequentially input at least one of a tilt angle that is an angle formed between the display 31 and the input unit 11, and an azimuth angle that is an angle formed between a straight line of the input unit 11 projected on the display 31 and a prescribed line.

FIG. 2 is a diagram illustrating an example of the tilt angle and the azimuth angle according to the first embodiment. As illustrated in FIG. 2, a tilt angle θ is an angle formed between the display 31 and the input unit 11. An azimuth angle φ is an angle formed between a reference line 43 and a projection line 44, in a virtual circle 42 having its center at a point position 41 of the input unit 11. The reference line 43 is in one side direction of the display 31, and the projection line 44 is a line of the input unit 11 projected on the display 31.

The tilt angle and the azimuth angle can be detected by, for example, in the case of an electromagnetic induction system, detecting the position of electric power generated by resonance caused by a reaction of a plurality of coils embedded in the input unit 11 (an electronic pen) with an AC allowed to flow through an antenna coil extending all over the display 31 (a touch panel), on the antenna coil side, to scan a plurality of positions of electric power. Alternatively, for example, the tilt angle and the azimuth angle can be detected by embedding an acceleration sensor or an angular velocity sensor in the input unit 11.

In the first embodiment, the input unit 11 sequentially inputs a point position, a pressure acting on the point position, a tilt angle and an azimuth angle, but the information input by the input unit 11 is not limited thereto.

An example of the information (stroke information) input by the input unit 11 during a period from being brought into contact with the display 31 to being moved apart from the display 31 (from pen down to pen up) includes {(x(1,1), y(1,1), p(1,1), r(1,1), s(1,1)), (x(1,N(1)), y(1,N(1)), p(1,N(1)), r(1,N(1)), s(1,N(1)))}. Here, x indicates an x-coordinate of the point position; y indicates a y-coordinate of the point position; p indicates a pressure (writing pressure) acting on the point position; r indicates a tilt angle; and s indicates an azimuth angle. N(i) indicates a score when sampling of an image i (the i-th stroke) is performed.

The acquisition unit 13 sequentially acquires the point position and the pressure acting on the point position that are input by the input unit 11. The acquisition unit 13 may further sequentially acquire at least one of the tilt angle and the azimuth angle.

In the first embodiment, the acquisition unit 13 is assumed to sequentially acquire the point position, the pressure acting on the point position, the tilt angle and the azimuth angle.

The analyzer 15 sequentially analyzes the point position and the pressure that are sequentially acquired by the acquisition unit 13. Specifically, the analyzer 15 sequentially analyzes the point position and the pressure sequentially acquired by the acquisition unit 13, to analyze a value and a change of the pressure at the point position.

The analyzer 15 further sequentially analyzes at least one of the tilt angle and the azimuth angle that are sequentially acquired by the acquisition unit 13. Specifically, the analyzer 15 further sequentially analyzes at least one of the tilt angle and the azimuth angle sequentially acquired by the acquisition unit 13, to analyze a gesture of the input unit 11. Examples of the gesture include movement and resting of the input unit 11.

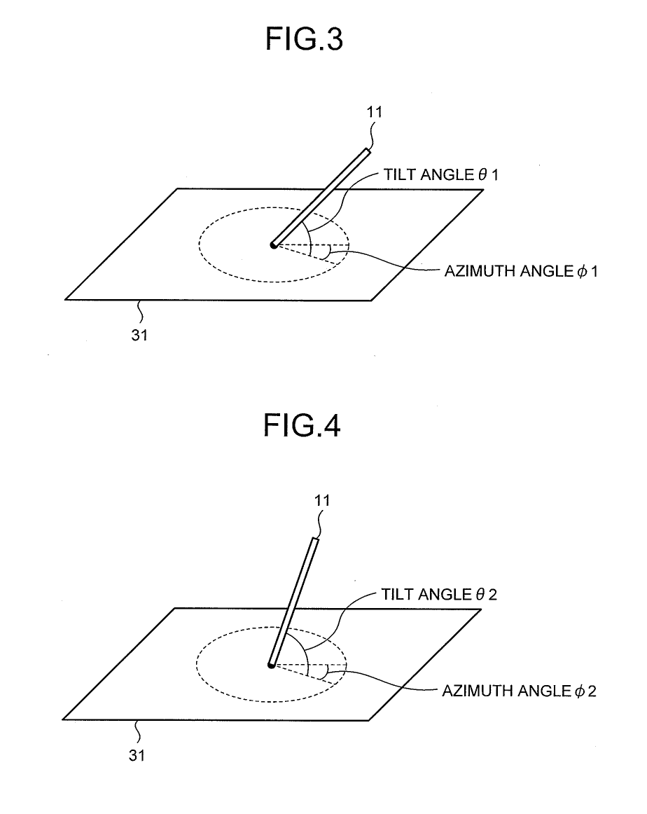

FIG. 3 and FIG. 4 are diagrams for explaining an example of the analysis method of a gesture according to the first embodiment. As illustrated in FIG. 3 and FIG. 4, it is assumed that the input unit 11 is changed from the state illustrated in FIG. 3 to the state illustrated in FIG. 4. In this case, the analyzer 15 calculates a tilt angle change θ′=θ2−θ1 and an azimuth angle change φ′=φ2−φ1 when changed from the state illustrated in FIG. 3 to the state illustrated in FIG. 4. Then, the analyzer 15 determines to be a movement gesture when θ′ and φ′ are larger than a threshold γ, and to be a resting gesture when θ′ and φ′ are smaller than the threshold γ.

The analyzer 15 may analyze the whole stroke acquired by the acquisition unit 13. An example thereof will be described later.

The region setting unit 17 sets a region of interest on the display 31, based on the analysis result by the analyzer 15. For example, the region setting unit 17 sets a region of interest on the display 31, based on the value of the pressure at the point position.

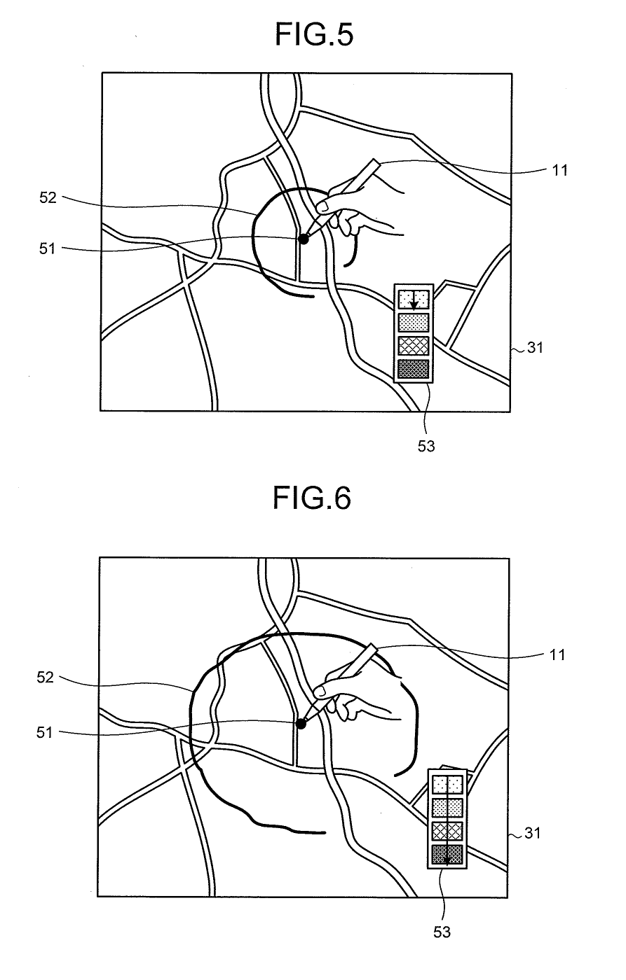

FIG. 5 and FIG. 6 are diagrams for explaining an example of the region of interest setting method according to the first embodiment. As illustrated in FIG. 5 and FIG. 6, the region setting unit 17 sets, as a region of interest, a circular region 52 having its center at an point position 51 based on a value of a pressure at the point position 51 of the input unit 11 on the display 31. At this time, the region setting unit 17 allows the circular region 52 to become larger as the value of the pressure at the point position 51 is larger. For example, in the case of an example illustrated in FIG. 5, since the value of the pressure at the point position 51 is smaller than that in the example illustrated in FIG. 6 (see a graph 53 indicating the magnitudes of the values of the pressures in FIG. 5 and FIG. 6), the size of the circular region 52 is smaller than that in the example illustrated in FIG. 6.

In order to inhibit an effect of swinging of the point position 51, the gravity center of the point position 51 for a certain period may be defined as the point position 51 for the certain period.

Alternatively, for example, the region setting unit 17 may set a region of interest on the display 31, based on the movement and the resting of the input unit 11. For example, the region setting unit 17 enlarges a circular region with centering an point position while the input unit 11 is in the movement gesture, and fixes the circular region when the input unit 11 becomes in the resting gesture, thereby to set the region of interest.

Still alternatively, for example, when the analysis result of the analyzer 15 shows that a stroke input by the input unit 11 constitutes a closed loop, the region setting unit 17 may set the closed loop region as a region of interest. Here, a method for analyzing whether or not a stroke by the analyzer 15 constitutes a closed loop will be described.

The analyzer 15 can easily analyze that a stroke constitutes a closed loop when end points of the input stroke overlap each other. However, in practice, there is often a case where the end points of the input stroke do not overlap each other, but a user having inputting the stroke intends a closed loop.

For this reason, the analyzer 15 determines whether or not the distance between the end points of the input stroke is shorter than a reference length N, or whether or not an intersection exists. For example, the reference length N can be set to be 0.05 times the length of an input stroke or the length of a short side of a circumscribed rectangle of a stroke.

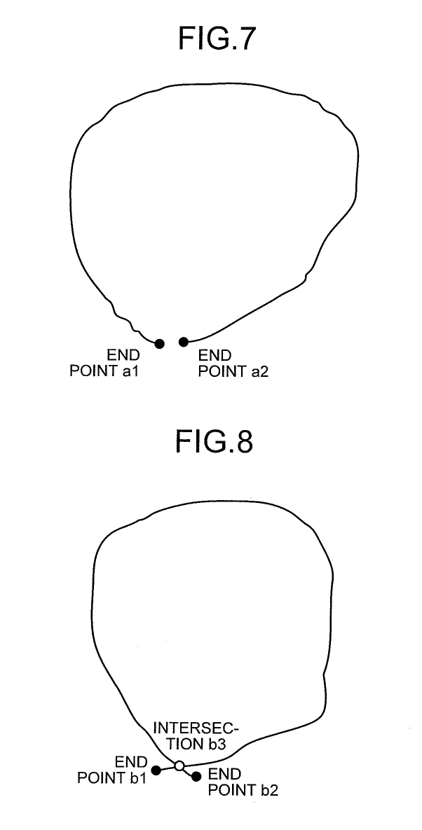

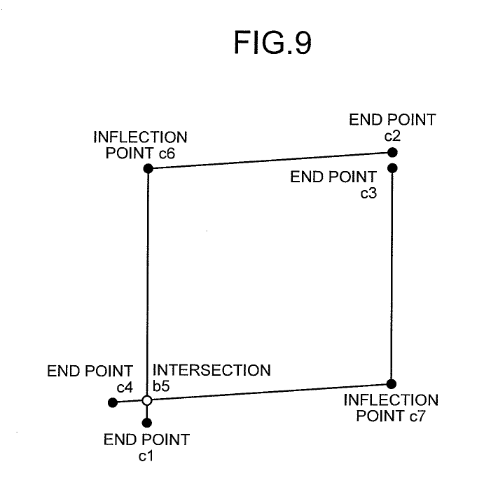

FIG. 7 to FIG. 9 are each an illustrative diagram of an example of the determination method of a closed loop according to the first embodiment. In the case of an example illustrated in FIG. 7, a Euclidean distance between the end point a1 and the end point a2 is given by |a1−a2|, and if |a1−a2|<N is satisfied, the analyzer 15 determines that the stroke constitutes a closed loop. In the case of an example illustrated in FIG. 8, a Euclidean distance between the end point b1 and the end point b2 is given by |b1−b2|, and even if |b1−b2|<N is not satisfied, an intersection b3 exists. Therefore, the analyzer 15 analyzes that the stroke constitutes a closed loop. In the case of an example illustrated in FIG. 9, a closed loop is input with a plurality of strokes. In this case, the analyzer 15 also analyzes that the stroke constitutes a closed loop, if the analyzer can determine, for example, that the distance between the end points close to each other is shorter than the reference length N (specifically, a Euclidean distance between the end point c2 and the end point c3 is given by |c2−c3|, and if |c2−c3|<N is satisfied), or that an intersection exists (specifically, an intersection b5 close to end points c1 and c4 exists).

Alternatively, for example, as a result of the analysis by the analyzer 15, the region setting unit 17 may set, as a region of interest, the circumscribed rectangle of the stroke input by the input unit 11.

The state setting unit 19 sets a region of interest to be in a change state, based on the analysis result of the analyzer 15 after the region of interest has been set by the region setting unit 17. For example, the state setting unit 19 sets the region of interest to be in the change state, based on a change of a pressure at the point position after the region of interest has been set. For example, the state setting unit 19 sets a region of interest to be in the change state, if, for a certain period of time, there is no change of a pressure at the point position after the region of interest has been set. Alternatively, for example, the state setting unit 19 may set a region of interest to be in the change state, based on the movement and the resting of the input unit 11. For example, the state setting unit 19 may set a region of interest to be in the change state when the input unit 11 changes from the movement gesture to the resting gesture, and may release the change state of the region of interest when the input unit 11 changed from the resting gesture to the movement gesture.

The notification controller 21 causes the notification unit 23 to notify that the region of interest has been set to be in the change state by the state setting unit 19. The notification may be screen output, speech output, light output or vibration output by the notification unit 23.

The change unit 25 changes the substance displayed in the region of interest, of the content displayed on the display 31, while the region of interest is fixed, based on the analysis result after the region of interest has been set by the region setting unit 17. Specifically, the change unit 25 changes the substance displayed in the region of interest, of the content, in a state of fixing the region of interest, based on the analysis result after the change state has been set by the state setting unit 19. For example, the change unit 25 changes the substance displayed in the region of interest, of the content, while the region of interest is fixed, based on the change of the pressure at the point position after the change state has been set.

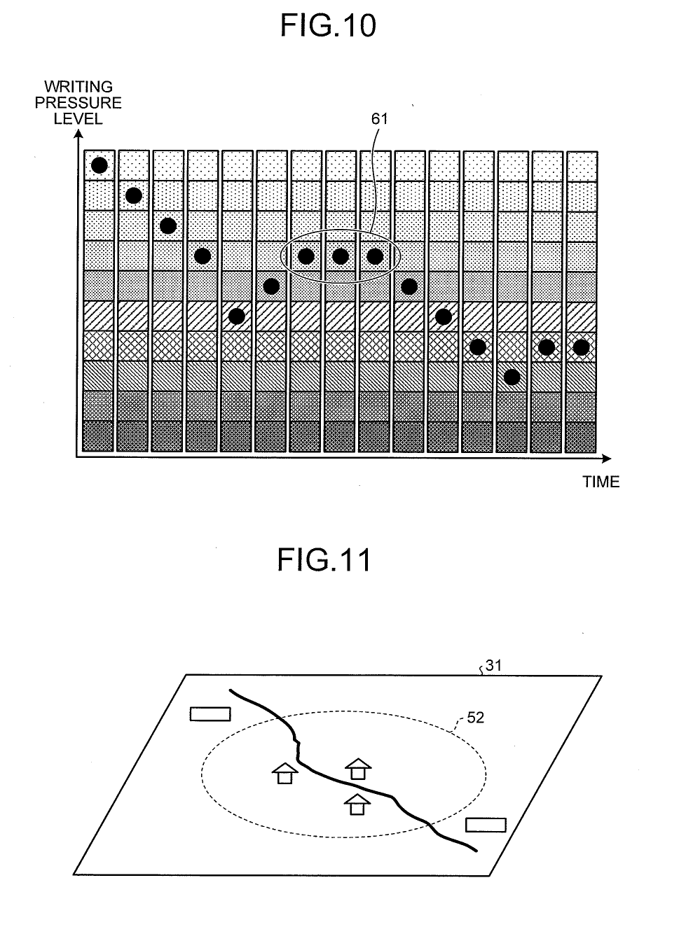

In the first embodiment, the change state is a zoom state, and the change unit 25 zooms (zooms in or zooms out) the substance displayed in the region of interest, of the content, while the region of interest is fixed, based on the analysis result after the change state has been set by the state setting unit 19. For example, as illustrated in FIG. 10, after the pressure level (writing pressure level) is stable for a certain period of time (see period 61), that is, after the state where the pressure level is not changed for a certain period of time, the change unit 25 performs zoom-in operation while the region of interest is fixed when the pressure level becomes higher, and performs zoom-out operation while the region of interest is fixed when the pressure level becomes lower. It is noted that when the change unit 25 performs zoom-out operation while the region of interest is fixed, the substance of the content displayed in an external region outside the region of interest may also be zoomed out.

The storage 27 stores content.

The display controller 29 acquires content from the storage 27, and displays the acquired content on the display 31. When the substance displayed in the region of interest of the content is changed by the change unit 25, the display controller 29 displays the changed substance in the region of interest.

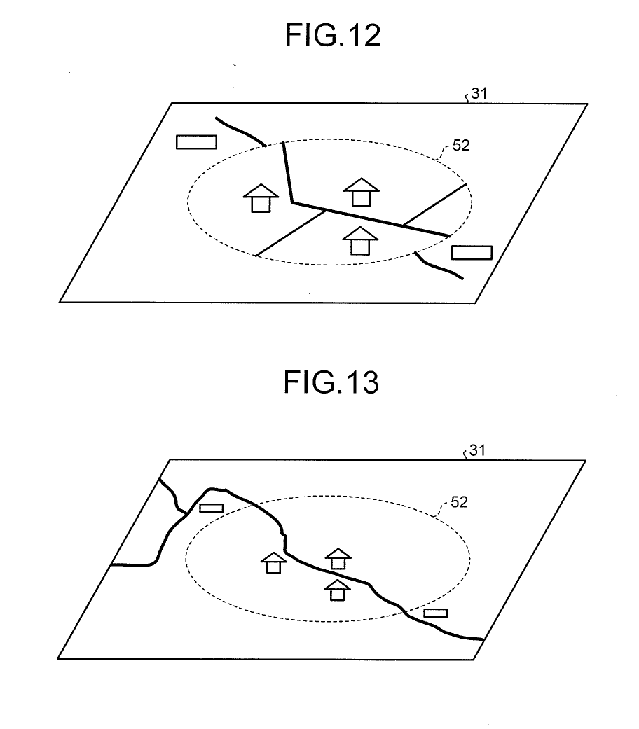

FIG. 11 to FIG. 13 are each an illustrative diagram of an example of the changed substance in the region of interest according to the first embodiment. In the example illustrated in FIG. 11, a default state of the substance displayed in the region of interest 52 on the display 31 is indicated. In the example illustrated in FIG. 12, a zoom-in state of the substance displayed in the region of interest 52 on the display 31 is indicated. In the example illustrated in FIG. 13, a zoom-out state of the substance displayed in the region of interest 52 on the display 31 is indicated. In the examples illustrated in FIG. 11 and FIG. 12, the change unit 25 displays the substance displayed outside the region of interest 52 as it is. However, as in the example illustrated in FIG. 13, when the substance displayed in the region of interest 52 is zoomed out, the substance displayed outside the region of interest 52 may also be zoomed out.

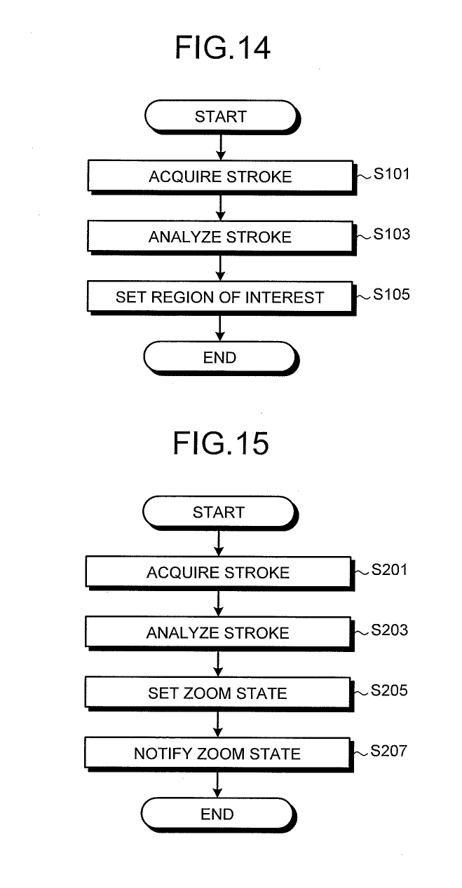

FIG. 14 is a flow chart illustrating an example of the procedure flow of the region setting process performed in the display apparatus 10 according to the first embodiment.

First, the acquisition unit 13 acquires a stroke that is input by the input unit 11 (the point position, the pressure acting on the point position, the tilt angle, and the azimuth angle) (step S101).

Subsequently, the analyzer 15 analyzes the stroke acquired by the acquisition unit 13 (step S103).

Subsequently, the region setting unit 17 sets a region of interest on the display 31, based on the analysis result of the analyzer 15 (step S105).

FIG. 15 is a flow chart illustrating an example of the procedure flow of the zoom state setting process performed in the display apparatus 10 according to the first embodiment.

First, the acquisition unit 13 acquires a stroke that is input by the input unit 11 (the point position, the pressure acting on the point position, the tilt angle, and the azimuth angle) (step S201).

Subsequently, the analyzer 15 analyzes the stroke acquired by the acquisition unit 13 (step S203).

Subsequently, the state setting unit 19 sets a region of interest to be in the zoom state, based on the analysis result of the analyzer 15 (step S205).

Subsequently, the notification controller 21 causes the notification unit 23 to notify that the region of interest has been set to be in the zoom state by the state setting unit 19 (step S207).

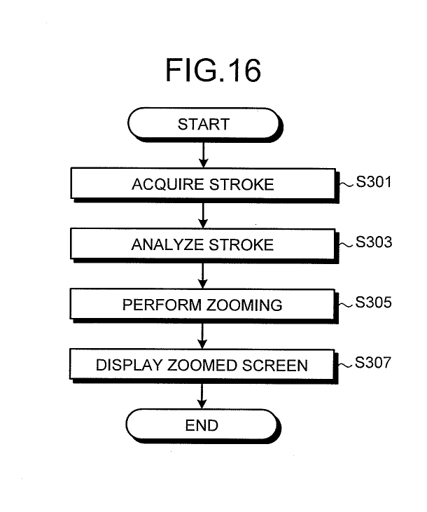

FIG. 16 is a flow chart illustrating an example of the procedure flow of the change process performed in the display apparatus 10 according to the first embodiment.

First, the acquisition unit 13 acquires a stroke that is input by the input unit 11 (the point position, the pressure acting on the point position, the tilt angle, and the azimuth angle) (step S301).

Subsequently, the analyzer 15 analyzes the stroke acquired by the acquisition unit 13 (step S303).

Subsequently, the change unit 25 zooms the substance displayed in the region of interest, of the content displayed on the display 31, while the region of interest is fixed, based on the analysis result (step S305).

Subsequently, when the substance displayed in the region of interest is zoomed by the change unit 25, the display controller 29 displays the zoomed substance in the region of interest (step S307).

As described above, according to the first embodiment, the substance displayed in the region of interest, of the content, is changed while the region of interest is fixed. Accordingly, the substance of the content displayed in the region of interest can be changed without reducing the visibility outside the region of interest. Especially, even when the substance displayed in the region of interest is zoomed in, the region of interest is still fixed, so that the region outside the region of interest is not hidden. This is suitable when zooming the region of interest while overlooking the substance outside the region of interest.

Further, according to the first embodiment, when zooming out the substance displayed in the region of interest, the substance outside the region of interest is also zoomed out. This is suitable when zooming the region of interest while overlooking the substance outside the region of interest.

Furthermore, according to the first embodiment, since the change of the substance displayed in the region of interest is performed based on the change of the pressure (in particular, based on the change after the pressure is stabilized), the operation to an input unit for zooming out also becomes easier.

### Second Embodiment

In a second embodiment, an example of inputting a stroke in a region of interest will be described. Hereinafter, a difference from the first embodiment will be mainly described. Constituents having the same functions as in the first embodiment are assigned with names and reference numerals similar to those in the first embodiment, and a description thereof will be omitted.

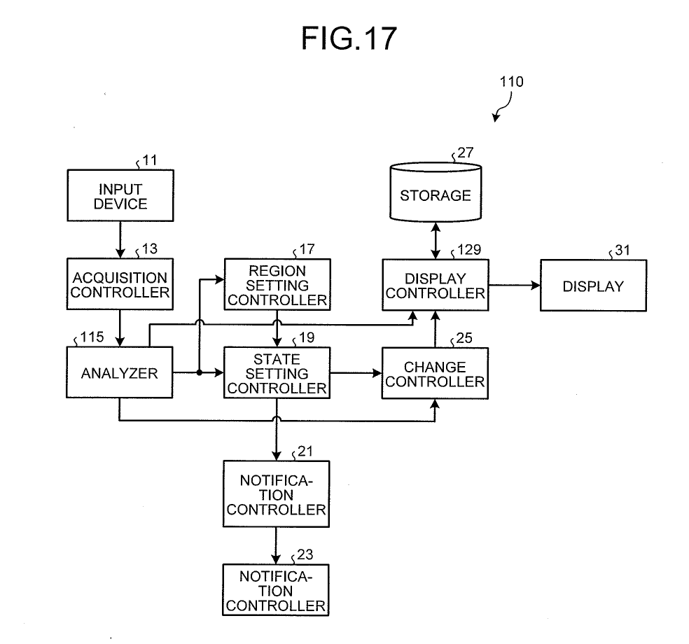

FIG. 17 is a block diagram illustrating a configuration example of a display apparatus 110 according to the second embodiment. As illustrated in FIG. 17, in the display apparatus 110 according to the second embodiment, an analyzer 115 and a display controller 129 are different from in the first embodiment.

The acquisition unit 13 acquires a stroke that is input from the input unit 11 to a region of interest.

The analyzer 115 analyzes whether or not the stroke acquired by the acquisition unit 13 is a stroke input to the region of interest.

Specifically, the analyzer 115 determines whether the input stroke is a stroke for operation or a stroke for writing, based on a trace, an end point position, a circumscribed rectangle and the like of an input stroke. For example, the analyzer 115 can determine that the input stroke is the stroke for operation, when a trace from an end point to another end point falls within a certain range. For example, the analyzer 115 can determine that the input stroke is the stroke for operation of setting a region of interest, when a brushstroke from an end point to another end point constitutes a closed loop. Therefore, when a stroke other than these, that is, a stroke other than the strokes for operation is input, the analyzer 115 can determine that the input stroke is a stroke for writing.

The display controller 129 further displays a stroke acquired by the acquisition unit 13 in a region of interest. Specifically, when the analyzer 115 analyzes the input stroke is the stroke input to a region of interest, the display controller 129 further displays the stroke in the region of interest.

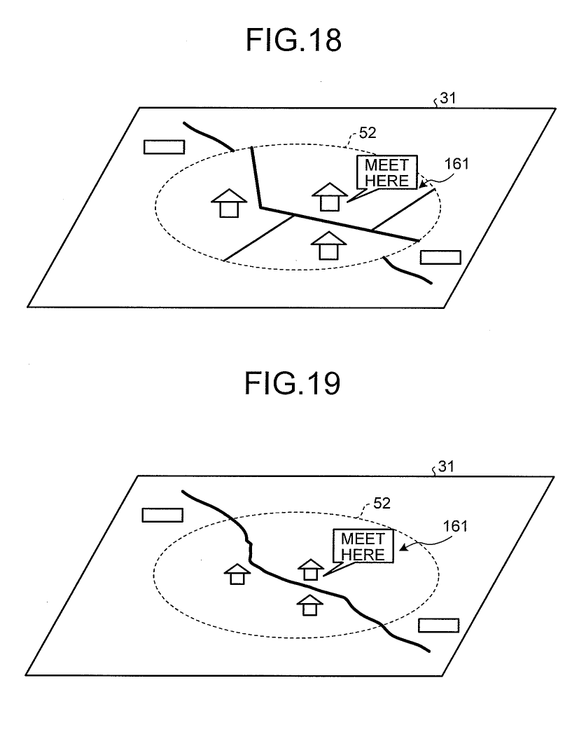

When a text stroke 161 for writing is input in the region of interest 52 as illustrated in FIG. 18, it is preferred, as illustrated in FIG. 19, that the change unit 25 performs zoom-out operation while the region of interest 52 is fixed without zooming out the text stroke 161. In this manner, a stroke for writing can be controlled and displayed independently of the content.

As above, according to the second embodiment, with the same input unit, the change of the substance of content displayed in a region of interest and the writing to the region of interest can be achieved.

### Modification

In the above-mentioned embodiments, the change of a spatial axis, that is, zooming, has been described as an example of the change state. However, the change state may be a temporal axis (past, present, future (estimation)). In this case, the change unit 25 may change, in terms of a temporal axis, the substance displayed in the region of interest, of the content, while the region of interest is fixed, based on the analysis result after the change state has been set by the state setting unit 19.

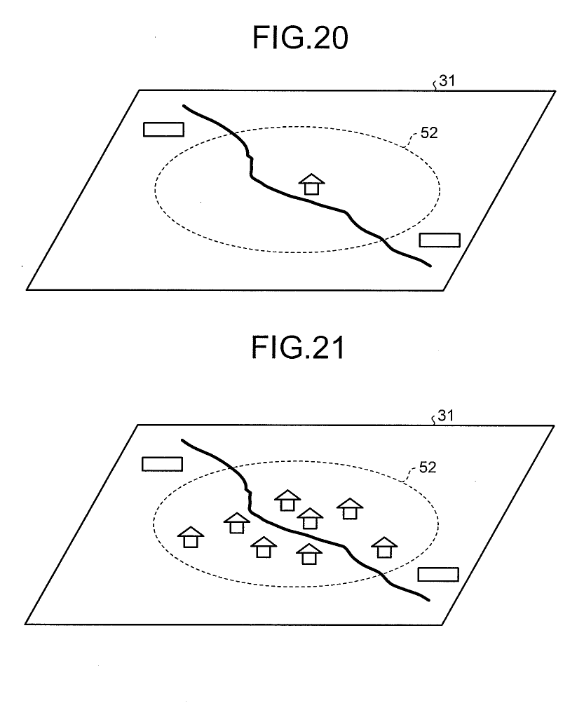

FIG. 20 and FIG. 21 are each an illustrative diagram of an example of the changed substance in the region of interest according to the modification. The example illustrated in FIG. 20 indicates a state where the substance displayed in the region of interest 52 on the display 31 is shifted in terms of a temporal axis from the state illustrated in FIG. 11 to the past. The example illustrated in FIG. 21 indicates a state where the substance displayed in the region of interest 52 on the display 31 is shifted in terms of a temporal axis from the state illustrated in FIG. 11 to the future. Operation for changing the substance into the state of being shifted in terms of a temporal axis to the past may be similar to the zoom-out operation in the above-described embodiments, and operation for changing the substance into the state of being shifted in terms of a temporal axis to the future may be similar to the zoom-in operation in the above-described embodiments.

Hardware Configuration

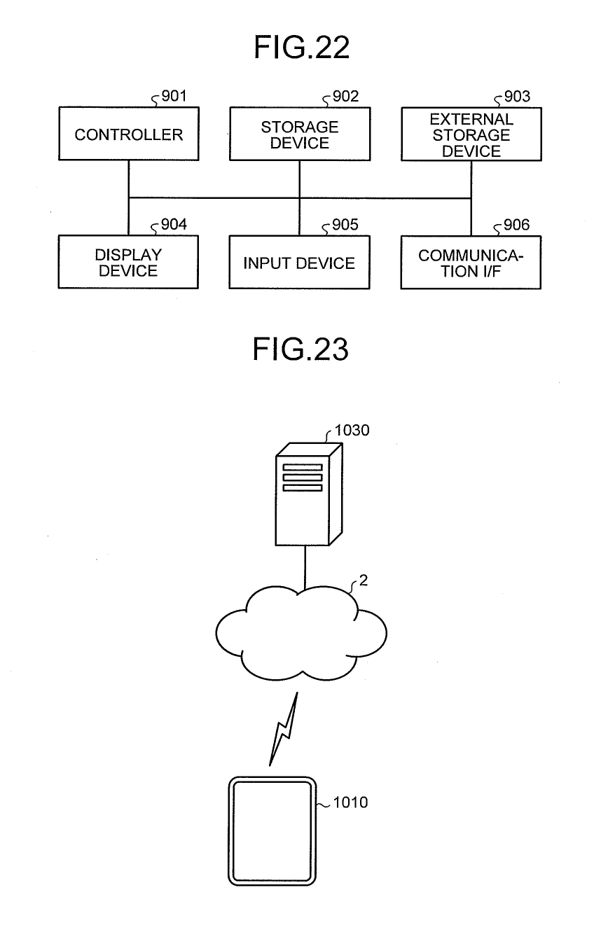

FIG. 22 is a block diagram illustrating an example of the hardware configuration of the display apparatus according to each of the embodiments and the modification described above. As illustrated in FIG. 22, the display apparatus according to each of the embodiments and the modification described above includes a controller 901 such as a CPU, a storage device 902 such as a ROM and a RAM, an external storage device 903 such as an HDD and an SSD, a display device 904 such as a display, an input device 905 such as a mouse and a keyboard, and a communication I/F 906, and can be achieved by a hardware configuration utilizing a common computer.

A program to be executed in the display apparatus according to each of the embodiments and the modification described above is provided by being previously incorporated into a ROM or the like.

Further, a program to be executed in the display apparatus according to each of the embodiments and the modification described above may be provided by being stored in a storage medium that can be read by a computer in a file of an installable format or an executable format. Examples of such a storage medium may include a CD-ROM, a CD-R, a memory card, a DVD and a flexible disk (FD).

Furthermore, a program to be executed in the display apparatus according to each of the embodiments and the modification described above may be provided by being stored on a computer connected to a network such as the Internet and being downloaded via a network. A program to be executed in the display apparatus according to each of the embodiments and the modification described above may be provided or distributed via a network such as the Internet.

A program to be executed in the display apparatus according to each of the embodiments and the modification described above has a module structure for achieving the above-described units on a computer. As actual hardware, for example, the controller 901 retrieves a program from the external storage device 903 to the storage device 902, and executes the retrieved program, thereby to achieve the above-described units on a computer.

Alternatively, the functions of the display apparatus according to each of the embodiments and the modification described above may be dispersedly executed, as illustrated in FIG. 23, in the display apparatus 1010 and a server 1030 connected with the display apparatus 1010 through a network 2.

As described above, according to each of the embodiments and the modification described above, the substance of the content displayed in the region of interest can be changed without reducing the visibility of the outside of the region of interest.

For example, the steps in the flow charts of the above-described embodiments may be changed in an execution order, may be plurally executed in a simultaneous manner, or may be executed in a different order for each implementation, unless the nature of the steps is not violated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display apparatus comprising:
an acquisition controller to sequentially acquire a point position of an input device on a display that displays content, and a pressure acting on the point position;
a region setting controller to set a region of interest on the display, based on the point position and the pressure that are sequentially acquired;
a change controller to change, based on the pressure, substance displayed in the region of interest, of the content, while the region of interest is fixed; and
a display controller to display the changed substance in the region of interest.

2. The apparatus according to claim 1, further comprising an analyzer to sequentially analyze the point position and the pressure, wherein
the region setting controller sets the region of interest based on an analysis result, and
the change controller changes, based on the analysis result, the substance of the content, while the region of interest is fixed.

3. The apparatus according to claim 2, further comprising a state setting controller to set the region of interest to be in a change state, based on the analysis result after the region of interest has been set, wherein
the change controller changes, based on the analysis result after the change state has been set, the substance of the content, while the region of interest is fixed.

4. The apparatus according to claim 2, wherein the analyzer sequentially analyzes the point position and the pressure, to analyze a value or a change of the pressure at the point position.

5. The apparatus according to claim 2, wherein
the acquisition controller further sequentially acquires at least one of a tilt angle that is an angle formed between the display and the input device, and an azimuth angle that is an angle formed between a straight line of the input device projected on the display and a prescribed line, and
the analyzer further sequentially analyzes at least one of the tilt angle and the azimuth angle that are sequentially acquired.

6. The apparatus according to claim 5, wherein the analyzer further sequentially analyzes at least one of the tilt angle and the azimuth angle that are sequentially acquired, to analyze a gesture of the input device.

7. The apparatus according to claim 6, wherein the gesture is movement and resting of the input device.

8. The apparatus according to claim 4, wherein the region setting controller sets the region of interest on the display, based on the value of the pressure at the point position.

9. The apparatus according to claim 7, wherein the region setting controller sets the region of interest on the display, based on the movement and the resting of the input device.

10. The apparatus according to claim 4, wherein the state setting controller sets the region of interest to be in a change state, based on the change of the pressure at the point position after the region of interest has been set.

11. The apparatus according to claim 7, wherein the state setting controller sets the region of interest to be in a change state, based on the movement and the resting of the input device.

12. The apparatus according to claim 4, wherein the change controller changes, based on the change of the pressure at the point position after the change state has been set, the substance displayed in the region of interest, of the content, while the region of interest is fixed.

13. The display apparatus according to claim 3, further comprising a notification controller to cause a notification controller to notify that the region of interest has been set to be in the change state.

14. The apparatus according to claim 3, wherein
the change state is a zoom state, and
the change controller zooms, based on the analysis result after the change state has been set, the substance of the content, while the region of interest is fixed.

15. The apparatus according to claim 14, wherein when the change controller zooms out, based on the analysis result after the change state has been set, the substance of the content, while the region of interest is fixed, the change controller also zooms out substance displayed in an external region outside the region of interest.

16. The apparatus according to claim 3, wherein
the change state is a state in which a temporal axis is changed, and
the change controller changes, based on the analysis result after the change state has been set, the substance of the content, in terms of a temporal axis while the region of interest is fixed.

17. The apparatus according to claim 1, wherein
the acquisition controller further acquires an stroke that is input from the input device to the region of interest, and
the display controller further displays the stroke in the region of interest.

18. The apparatus according to claim 17, wherein the analyzer analyzes whether or not the acquired stroke is a stroke to be further displayed in the region of interest.

19. A display method comprising:
sequentially acquiring a point position of an input device on a display that displays content, and a pressure acting on the point position;
setting a region of interest on the display, based on the point position and the pressure that are sequentially acquired;
changing, based on the pressure, substance displayed in the region of interest, of the content, while the region of interest is fixed; and
displaying the changed substance in the region of interest.

20. A computer program product comprising a computer-readable non-transitory medium containing a program that causes a computer to execute:
sequentially acquiring a point position of an input device on a display that displays content, and a pressure acting on the point position;
setting a region of interest on the display, based on the point position and the pressure that are sequentially acquired;
changing, based on the pressure, substance displayed in the region of interest, of the content, while the region of interest is fixed; and
displaying the changed substance in the region of interest.
